(19) United States
(12) Patent Application Publication
(10) Pub. No.: US 2002/0076016 A1
(43) Pub. Date: Jun. 20, 2002

(54) Living information guidance system

(75) Inventors: Taiho Shu, Tokyo (JP); Tsuyoshi Murakami, Tokyo (JP); Takashi Terada, Tokyo (JP)

Correspondence Address: OLIFF & BERRIDGE, PLC, P.O. BOX 19928, ALEXANDRIA, VA, 22320, US

(73) Assignee: TAEIVON INFOTECH CO., LTD., Tokyo (JP)

(21) Appl. No.: 10/073,144

(22) Filed: Feb. 13, 2002

Related U.S. Application Data
(63) Continuation of application No. PCT/JP99/06828, filed on Dec. 7, 1999.

(30) Foreign Application Priority Data
Aug. 30, 1999 (JP) 11-242432
Sep. 20, 1999 (JP) 11-264774

(51) Int. Cl. H04M 11/00

(52) U.S. Cl. 379/93.12; 379/93.05

(57) ABSTRACT

The present invention is to provide a convenient living information guidance system, which is easily used for a resident of an apartment house, and reduces the load of management work for a management company of the apartment house, and includes such a shopping function that a dealer providing commodities or services can carry on more effective business. This living information guidance system comprises (1) a user terminal installed in a user residential building, (2) a first server which stores guidance information for the information provision and the shopping in the user residential area, and transmits necessary information to the user terminal in response to a user's request, and (3) a second server including a transaction information database for storing information concerning shopping performed by a user of the user terminal, means for receiving and storing into the transaction information database, an order for a commodity or a service, wherein the order is issued by the user terminal in accordance with the guidance information for the shopping stored in the first server, and means for notifying the order for the commodity or the service to a dealer for providing the commodity or the service.

### CROSS-REFERENCE TO RELATED APPLICATIONS

This is a continuation of International Application PCT/JP99/06828, filed Dec. 7, 1999, now abandoned.

### TECHNICAL FIELD OF THE INVENTION

The present invention relates to an information system used in an apartment house or the like, more particularly to a living information guidance system which enables information provision, shopping and the like in a user residential area.

### BACKGROUND OF THE INVENTION

Conventionally, an information system used in an apartment house or the like is merely composed of a network for connecting personal computers (PC) installed in the respective apartments of the apartment house or the like and a computer of a management company of the apartment house or the like, which is connected to the network. Even in such an information system, although information of a user residential area can be provided and a user can communicate with the management company, since the PC is used, everybody can not handle it, and an exchange of information with the outside of the network installed in the apartment house or the like has been impossible. Further, the management company must update the information of the user residential area, and the load of the management company has been heavy. Besides, although there is a system in which a connection with the Internet can be established from a network provided in an apartment house or the like, with respect to shopping, a large number of existing online shopping sites has to be used. With this sort of system, it is impossible to easily obtain distinctive shopping information having real relevance to a user residential area, a user residential building, or the like. Besides, in some of the online shopping sites of the Internet, a malicious person carries on business, and it is therefore impossible to use them with a light heart.

### SUMMARY OF THE INVENTION

An object of the present invention is to provide a convenient living information guidance system which is easily used in a resident of an apartment house or the like. Besides, another object is to provide a living information guidance system in which the load of management work can be reduced for a management company of the apartment house or the like. Besides, another object is to provide a living information guidance system having such a shopping function that a person providing goods or services can carry on more effective business.

Still another object of the invention is to provide a computer used for the living information guidance system. Besides, still another object is to provide a method executed in the living information guidance system. Further, still another object is to provide a program used for the living information guidance system.

A living information guidance system of a first aspect of the invention for enabling information provision and shopping in a user residential area comprises (1) a user terminal installed in a user residential building and including a display device, (2) a first server (for example, a resident server 130 installed in an apartment house or the like or a CATV server 330 installed in a cable television station) which stores guidance information for the information provision and the shopping in the user residential area, and transmits necessary information to the user terminal in response to a user's request, and (3) a second server (for example, a management company server 160 installed in a management company) including a transaction information database (for example, a transaction information database 140 of FIG. 1 or a transaction information database 380 of FIG. 16) for storing information relating to shopping done by a user, means for receiving and storing into the transaction information database, an order for a commodity or a service, wherein the order is issued by the user terminal in accordance with the guidance information for the shopping stored in the first server, and means for notifying a dealer for providing the commodity or the service of the order for the commodity or the service. Incidentally, at least part (for example, image information, database information) of the guidance information may be delivered to the first server through satellite communication. Besides, the first server may be installed in a cable television (CATV) station, and the first server and the user terminal may also be connected through a signal line for cable television program transmission.

By constructing the living information guidance system as stated above, for example, merits as described below are obtained. That is, for an operation management company which delivers at least part of the guidance information through the satellite communication, a large amount of information can be broadcasted through a satellite, and can transmit such information that an area or a server is specified, in large quantities and at high speed, so that operation costs (communication costs) are reduced. Besides, for the management company, since communication (mail, bulletin board, etc.) with user residents can be made, management of the residents becomes easy. Further, since the operation management company performs transmission (update) of content and the like, the load of management work is reduced. For a dealer for providing goods or services, since the person having the user terminal is restricted in an area (or in a building), more effective business can be carried on. Further, if information stored in the transaction information database is fed back, the marketing can be more effectively carried out. Technically, useful transaction information can be certainly stored by capturing orders by the second server, and the orders can be certainly transferred to the dealer. The dealer receives the order through the second server, so that the interface to the users can be unified.

Besides, in the case where a cable television infrastructure is used, that is, in the case where the first server is installed in the CATV station, and the first server and the user terminal are connected through the signal line for cable television program transmission, there are merits, for example, as described below. In many cases, since the CATV station is often already provided with satellite communication equipment, the operation management company can deliver data through the satellite communication in the same manner as the case where the first server is installed in the apartment house or the like. Even in the case where satellite communication equipment is not installed in the CATV station, data can be delivered from the operation management company to the CATV station through a wired communication line or the like. The CATV station can effectively use an existing communication network of the cable television station to connect the user terminal installed in a general house or an apartment house to the first server installed in the CATV station. Besides, since data transmission speed of the program transmission signal line is high, it is effective in the transmission of the living guidance information including a large amount of image information or the like to the user terminal.

The aforementioned display device of the user terminal can also be made a touch panel. By adopting the touch panel, it becomes possible to provide a user interface which can be more easily used for anybody.

Besides, the aforementioned user terminal may be provided with a function of transmitting and receiving an e-mail. This enables communication in the apartment house or the like, communication with the management company of the apartment house or the like, and communication with the outside.

In addition, there is also a case where the first server stores guidance information from the management company of the user residential building. With this, the management company can easily send the information to the users without using individual e-mail.

Besides, the living information guidance system may further comprise a third server for storing backup data of the first and the second servers, and the backup data may be delivered to the first or the second server requiring the backup data. Maintenance work by the operation management company can be easily carried out.

Further, it is also possible to adopt a configuration further comprising a fourth server for storing information of orders for commodities or services, which is connected to the second server and is installed in the operation management company. The operation management company may also hold a transaction information database and be capable of storing transaction information from the apartment houses or the like managed by a plurality of management companies. By this, the transaction information of a wider area is stored and can be used for marketing of goods or services.

Incidentally, the user terminal may access the Internet.

Besides, the aforementioned second server may further include means for providing transaction or marketing information, which is based on the order information stored in the transaction information database, for the dealer for providing commodities or services. By receiving feedback of the transaction information, the dealer can carry out more effective business activities.

A computer of a second aspect of the invention, which is used for a living information guidance system, comprises a transaction information database for storing information relating to shopping performed by a user, means for receiving and storing into the transaction information database, an order for a commodity or a service, wherein the order is issued by a user terminal in accordance with guidance information for shopping stored in user terminal response means (for example, the first server of the first aspect of the invention), and means for notifying the order for the commodity or the service to a dealer for providing the commodity or the service.

A living information guidance method of a third aspect of the invention comprises the steps of: (1) transmitting, in response to a request from a user terminal which is installed in a user residential building and includes a display device, guidance information relating to shopping to the user terminal from user terminal response means (for example, the first server of the first aspect of the invention) for storing guidance information for information provision and shopping in a user residential area, (2) if an order for a commodity or a service from the user terminal is received, storing information relating to shopping performed by a user into a transaction information database, and (3) notifying the order of the commodity or the service to a dealer for providing the commodity or the service.

A program of a fourth aspect of the invention for a living information guidance system causes a computer to execute the steps of: (1) receiving an order for a commodity or a service, wherein the order is issued by a user terminal in accordance with guidance information for shopping stored in user terminal response means (for example, the first server of the first aspect of the invention) and storing information relating to shopping performed by a user into a transaction information database, and (2) notifying a dealer for providing the commodity or the service of the order for the commodity or the service. The program as stated above is stored in a storage medium or a storage device, for example, a floppy disk, a CD-ROM, a magneto-optical disk, a semiconductor memory, a hard disk, or the like.

### BRIEF DESCRIPTION OF THE DRAWINGS

FIG. 1 is a block diagram showing the outline of a living information guidance system of a first preferred embodiment;

FIG. 2 is a view showing an example of a network in an apartment house or the like;

FIG. 3 is a view showing an example of a menu screen displayed on a user terminal 200;

FIG. 4 is a view showing an example of a display screen, which includes newly-arrived information, and is displayed on the user terminal 200;

FIG. 5 is a view showing an example of the display screen, which includes area information calendar, and is displayed on the user terminal 200;

FIG. 6 is a view showing an example of the display screen, which includes open space (bulletin board) of residents, and is displayed on the user terminal 200;

FIG. 7 is a view showing an example of the display screen, which includes today's simple recipe, and is displayed on the user terminal 200;

FIG. 8 is a view showing an example of the display screen, which includes medical information, and is displayed on the user terminal 200;

FIG. 9 is a view showing an example of the display screen, which includes neighborhood map, and is displayed on the user terminal 200;

FIG. 10 is a view showing an example of the display screen, which includes information from home management association, and is displayed on the user terminal 200;

FIG. 11 is a view showing an example of the display screen, which includes information from management company, and is displayed on the user terminal 200;

FIG. 12 is a view showing an example of the display screen for Internet displayed on the user terminal 200;

FIG. 13 is a view showing an example of the display screen for commodity ordering displayed on the user terminal 200;

FIG. 14 is a view showing an example of the display screen for a dealer in the commodity ordering displayed on the user terminal 200;

FIG. 15 is a flow diagram showing exchange of data between servers in the living information guidance system of the first preferred embodiment;

FIG. 16 is a block diagram showing the outline of a living information guidance system of a second preferred embodiment;

FIG. 17 is a block diagram showing the outline of a living information guidance system of a third preferred embodiment;

FIG. 18 is a flow diagram showing exchange of data between servers in the living information guidance systems of the second and third preferred embodiments; and

FIG. 19 is a flow diagram showing exchange of data between servers of the living information guidance systems of the second and third preferred embodiments in a case where a management company server does not exist.

### DETAILED DESCRIPTION OF THE PREFERRED EMBODIMENTS

1. First preferred embodiment

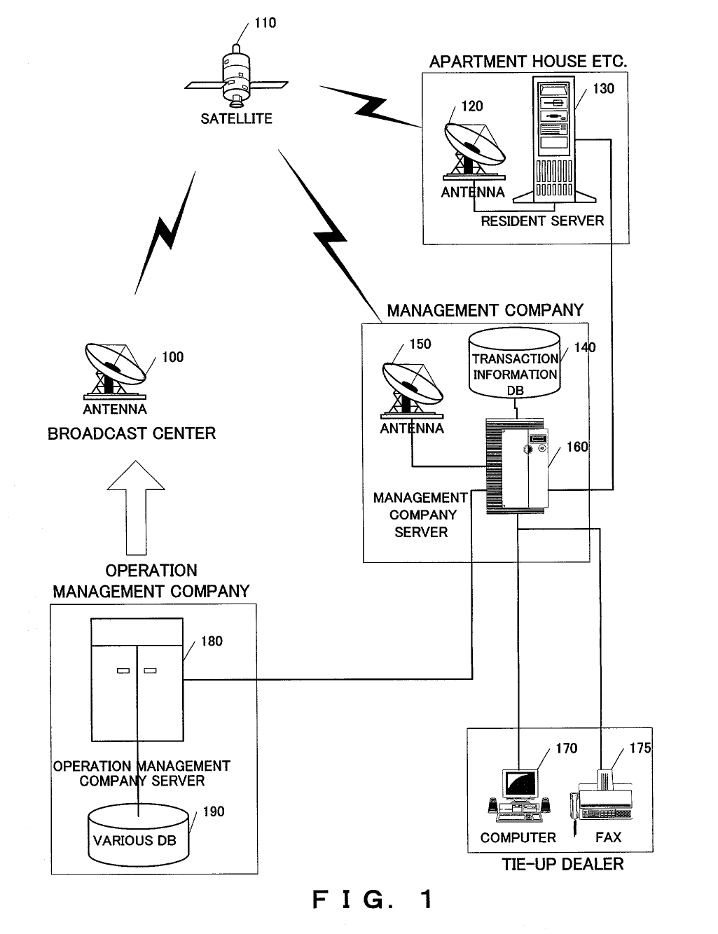

FIG. 1 is a view showing the whole of a living information guidance system of the first preferred embodiment. An operation management company is equipped with an operation management company server 180 and various databases 190 (which includes contents, transaction information, user needs, and customer information data bases). A broadcast center is equipped with an antenna 100 for transmitting data, distribution of which through satellite communication is requested by the operation management company, to a satellite 110. An apartment house or the like is equipped with an antenna 120 for receiving the data distributed from the satellite 110, and a resident server 130 for storing the received data, data transmitted from a management company, and data provided offline and for exchanging the data with user terminals not shown in FIG. 1. The management company of the apartment house or the like is equipped with a management company server 160, a transaction information database 140, and an antenna 150 for receiving the data distributed from the satellite 110. A tie-up dealer is equipped with, for example, a FAX 175 or a computer 170. The resident server 130 and the management company server 160, the management company server 160 and the operation management company server 180, and the management company server 160 and the computer 170 of the tie-up dealer are respectively connected through, for example, a private line.

The operation management company creates contents to be stored in the resident server 130 and to be provided for a user, collects material and information for that, and gives assistance to the management system operations of the management company. According to circumstances, the operation management company is entrusted by the management company and executes the management system operations. That is, the operation management company operates the management company server 160, the transaction information database 140 and the like for the management company on behalf of the management company,. Besides, the operation management company stores backup data of the resident server 130 and the management company server 160, and provides a backup function. Besides, as the need arises, the operation management company maintains the resident server 130 and the management company server 160. When version up of part or all of the system is executed, the operation management company carries out a necessary processing to the resident server 130 and the management company server 160. Further, it is also possible to operate a call center to respond to such as a question and/or a claim from the user as to the living information guidance system. Besides, the operation management company has the role of finding tie-up dealers for the shopping function of the living information guidance system. The number of operation management companies is normally one in this system.

The operation management company uses the operation management company server 180. This operation management company server 180 is connected to the management company server 160 through, for example, a private line, and since customer information modified or inputted by a computer (not shown) of the management company connected to the management company server 160 and transaction information described later are transmitted from the management company server 160, a customer information database and a transaction information database are maintained and managed on the basis of this received information. Besides, there is also a case where a user needs database is formed from the customer information database or the like. With respect to contents stored in the resident server 130, although there are original contents by the management company, most of the contents are distributed from the operation management company through the satellite communication. A contents database for storing the distributed contents is also maintained and managed in the operation management company server 180.

Since the broadcast center is merely requested by the operation management company to distribute data through satellite communication and transmits it to the satellite 110, its description is omitted in the following.

The apartment house or the like may be an apartment house itself or a general house. In the case of the apartment house, the resident server 130 is provided for every building or for every plural buildings. In the general house, the resident server 130 is normally provided for every plural houses in a predetermined area. It is also possible to provide the resident server 130 for a combination of the general house and the apartment house. In FIG. 1, although only one apartment house or the like is shown, the present invention is not limited to one. This system can be applied to many apartment houses or the like in a wider area by using the satellite communication. This is because a large amount of information can be broadcasted at high speed and over a wide area by using the satellite communication. Incidentally, the information distribution of the operation management company becomes effective. The satellite communication using the antenna 120 is used for receiving, for example, image information of the data to be stored in the resident server 130 or information of a database in a case where the database is held. All of the data stored in the resident server 130 maybe received through the satellite communication or a part thereof may be received. Besides, data for version up of the system and recovery data (backup data) in the case where the system gets out of order are also received through the satellite communication.

The management company of the apartment house or the like performs resident management (such as customer information management), building management, and the like. There is also a case where the management company has the role of finding tie-up dealers having closer relevance to the area. In FIG. 1, although only one management company is shown, the present invention is not limited to one. In the case where there are plural apartment houses or the like to which the present invention can be applied, plural management companies may exist correspondingly to that. By the same reason as that why many apartment houses or the like in a wider area come to be capable of using the present invention, many management companies in a wider area come to be capable of using this living information guidance system.

In the living information guidance system, the management company uses the management company server 160 to write necessary information on a bulletin board provided in the resident server 130 or to transmit individual e-mail to residents. In the case where shopping using the user terminal is done, ordering information of a commodity or a service is transmitted to the management company server 160 and is stored in the transaction information database 140 of the management company server 160. From the transaction information stored in the transaction information database 140, processed data, such as hot-selling information or the purchasing age cluster, can be provided for the tie-up dealer or the like. The antenna 150 for the satellite communication is mainly used for receiving the data for version up of this system or the recovery data (backup data) in the case where the system gets out of order. In the case where the tie-up dealer has necessary equipments, the communication with the tie-up dealer is carried out with the computer connected by a private line. In the case where the tie-up dealer doesn't have necessary equipment, a system becomes such that the management company server 160 transmits the ordering contents of the commodity or the service through the FAX.

The tie-up dealer is a person who provides commodities or services for the users of this living information guidance system. Since the users of this living information guidance system are specified and the area can also be restricted, this tie-up dealer can carry on more effective business. Besides, by using the feedback of the transaction information stored in the transaction information database and the information from the user needs database, commodities or the like to be provided can also be narrowed down, and further effective marketing can be carried out. Besides, since the ordering contents are notified from the management company server 160, the ordering information is certain, and an interface has only to be matched with the management company server 160. The tie-up dealer transfers, as an advertisement distribution request, information of commodities or the like to be provided through this living information guidance system, to the management company or the operation management company. In the case where it is transferred to the management company, the management company transfers it to the operation management company. The operation management company processes the received information (including image information) and creates information to be distributed.

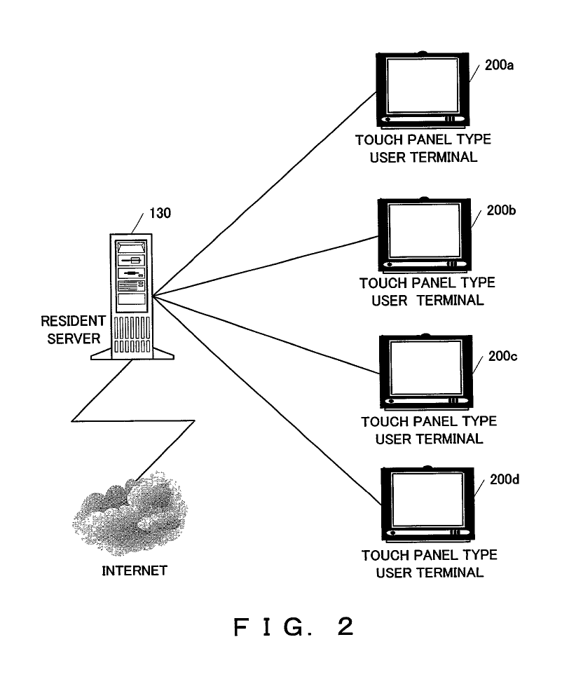

The outline of a network in the apartment house or the like will be described with reference to FIG. 2. The resident server 130 can be accessed from user terminals 200 of a touch panel type. Although the touch panel type may not be used, the touch panel type can provide a user-friendlier interface. At least one user terminal 200 is installed in every house. Although only four user terminals are shown in FIG. 2, the number thereof is not limited. The plural resident servers 130 may be provided according to the number of the user terminals 200. The type of the network is a LAN (Local Area Network).

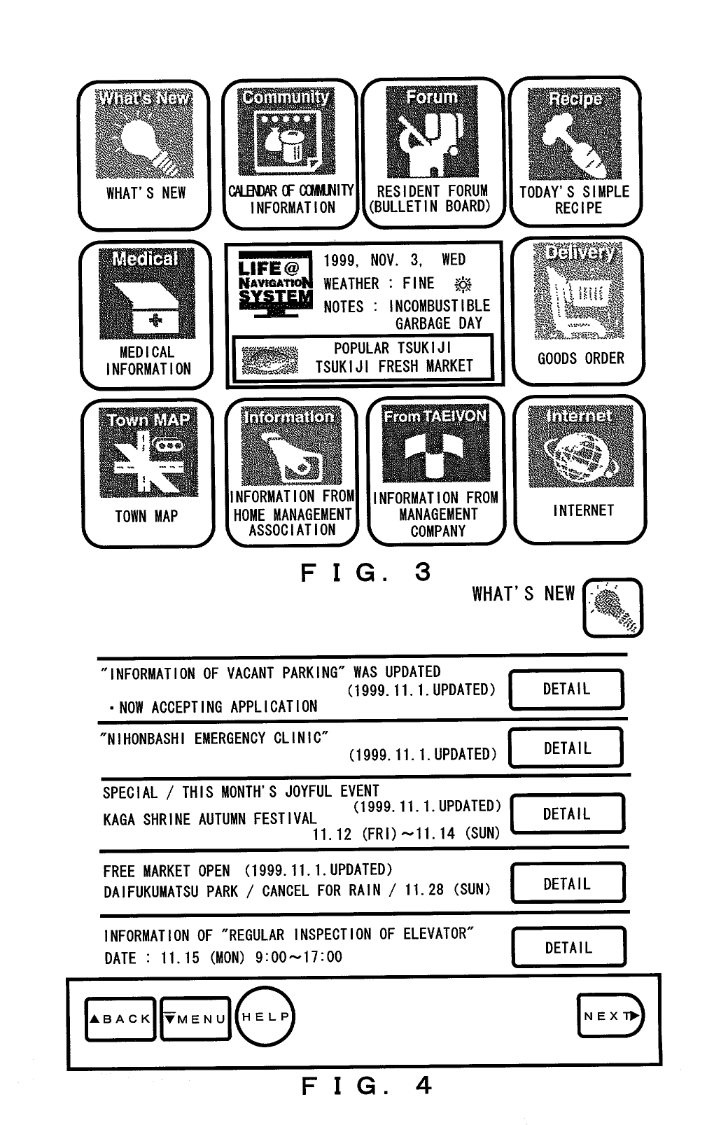

Here, examples of living guidance information provided from the resident server 130 for the user terminals 200 will be illustrated. FIG. 3 shows an example of a front page, that is, menu page. There are menu buttons of what's new, calendar of community information, resident forum (bulletin board), today's simple recipe, medical information, goods ordering, town map, information from home management association, information from management company, and Internet. When a user touches one of the ten menu buttons on the screen of FIG. 3, the contents of the respective menu items are displayed. Incidentally, in the example of the front page of FIG. 3, simple information such as date, weather, and date of incombustible garbage, together with an advertisement of a tie-up dealer, is displayed at the center.

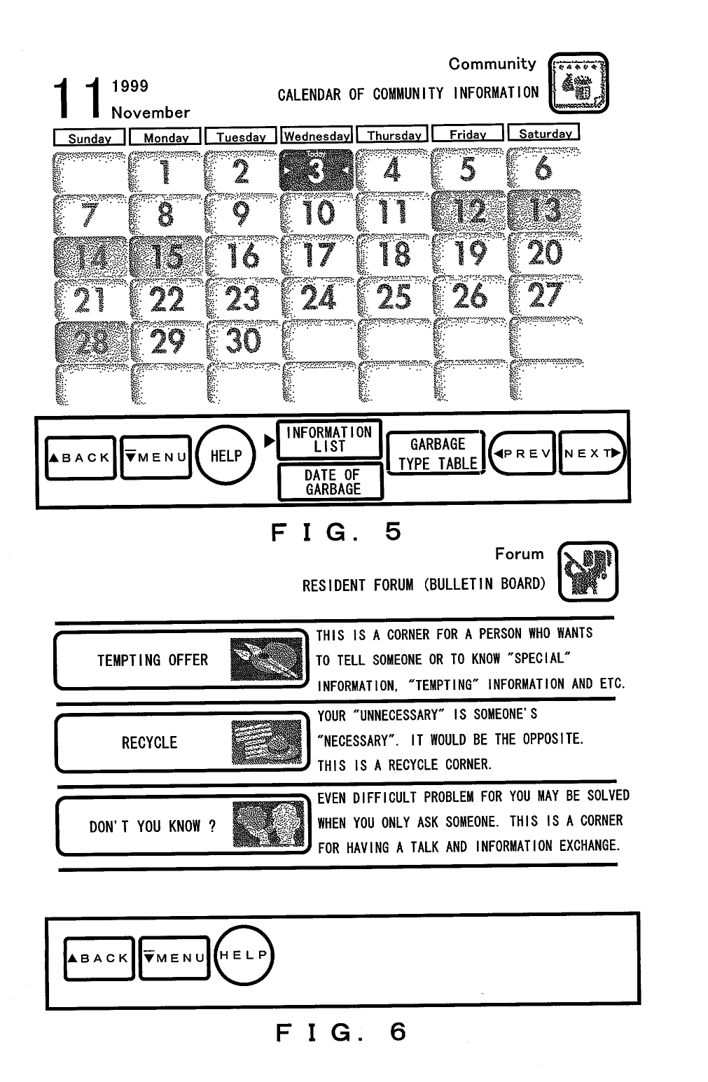

FIG. 4 shows an example of information displayed in the case where the user selects “WHAT'S NEW” in FIG. 3. Items of events and the like are indicated at respective lines, and further, more detailed information can be obtained by touching a button of “DETAIL”. At a lower portion of the screen, a display of buttons including “BACK” to return previous screen, “MENU” to return to menu screen, “HELP” to represent how to use, and “NEXT” to move to the next screen, is performed and is designed so that the user can easily operate. FIG. 5 shows an example of information displayed in the case where the user selects the calendar of community information in FIG. 3. Here, a display is presented such that toady's date can be seen. At a lower portion of the screen, in addition to the buttons described above, buttons intrinsic to the calendar of the community information, such as “INFORMATION LIST” and “date of garbage” for mode selection and “garbage type table”, are also displayed. There is also a display of “PREV” to move to former month and “NEXT” to move to next month.

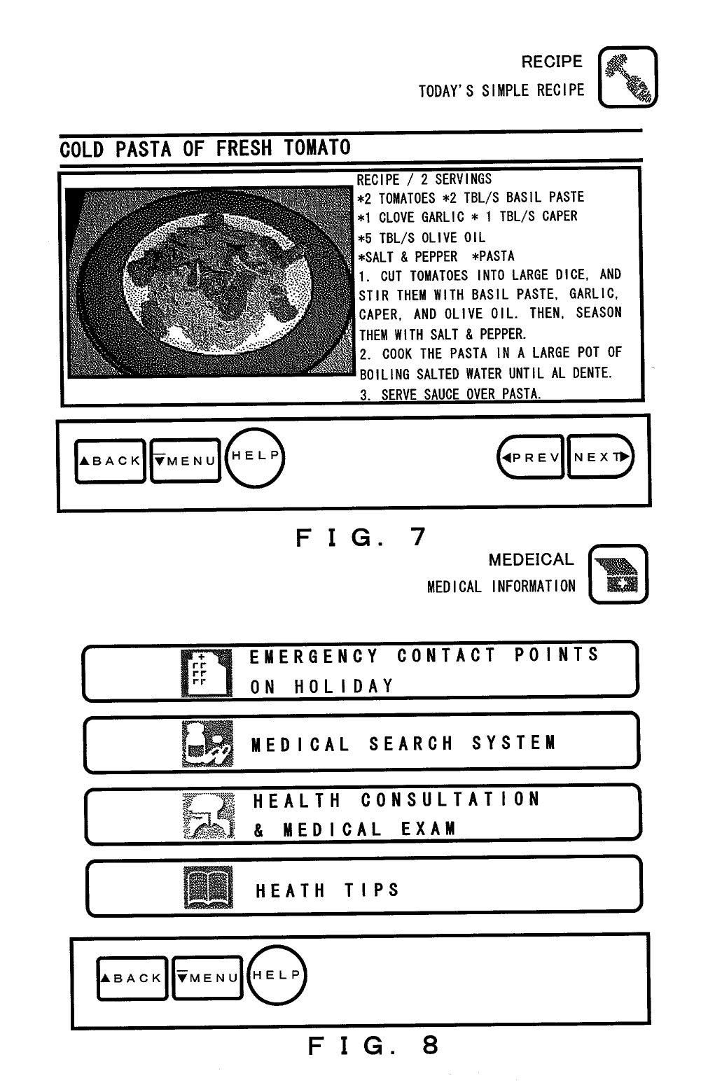

FIG. 6 shows an example of information displayed in the case where the button of the open space of residents in FIG. 3 is touched. At respective lines, there are items for facilitating communication of residents, such as “TEMPTING OFFER, “RECYCLE” and “DON'T YOU KNOW?”, and more detailed contents can be seen by selecting any one of these. In addition, residents can also input information. FIG. 7 shows an example of information displayed in the case where the button of the today's simple recipe in FIG. 3 is touched. Here, although only one dish (cold pasta of fresh tomato) is displayed, it is possible to configure to select a plurality of dishes.

FIG. 8 shows an example of information displayed in the case where the button of the medical information in FIG. 3 is touched. In FIG. 8, selectable items are provided at the respective lines. In the case where, in the item of medical search system is selected among these, the residents can search a database for medical information, and this database is constructed in the resident server 130. Concerning the contents of the database, although the management company may input information peculiar to the area, it may be what is distributed from the operation management company through the satellite communication.

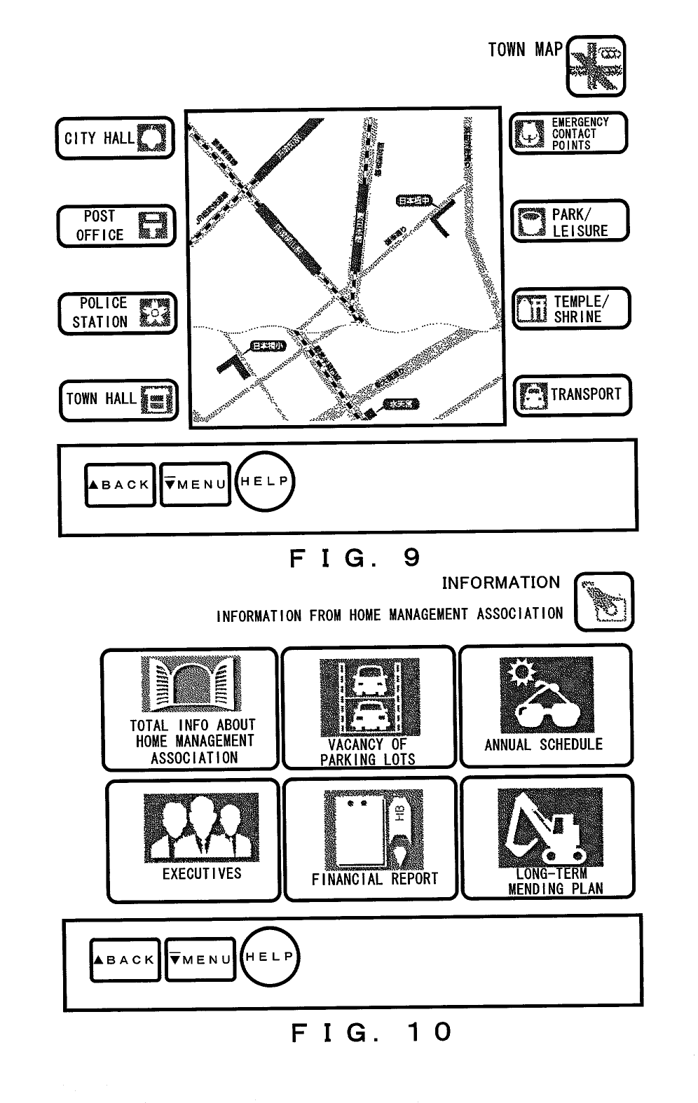

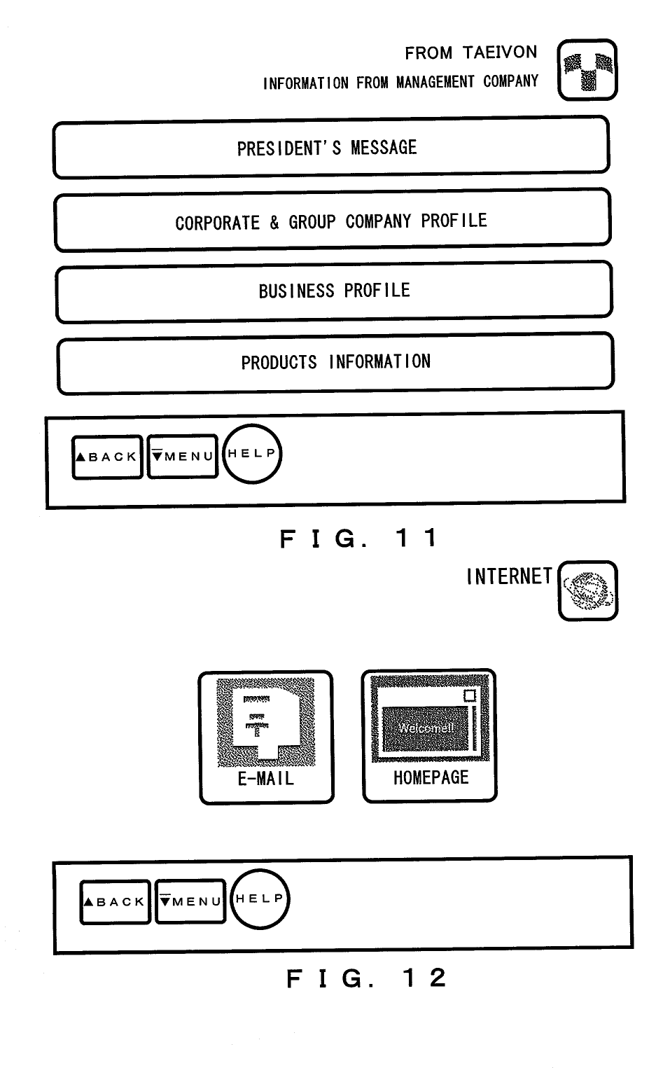

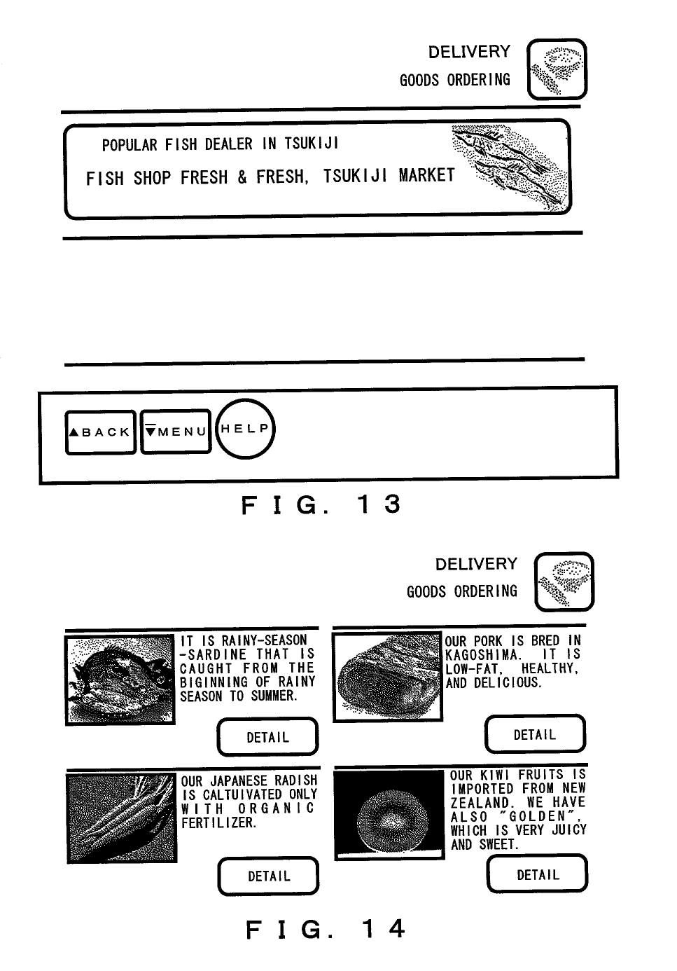

FIG. 9 shows an example of information displayed in the case where the button of the town map of FIG. 3 is selected. In FIG. 9, neighborhood facilities and agencies, such as a city hall, a post office, and a police station, can be easily searched. Besides, telephone numbers, addresses and the like can also be found at the respective items and the following. FIG. 10 shows an example of information displayed in the case where the button of the information from home management association in FIG. 3 is selected. In FIG. 10, items relating to the home management association are displayed, and if necessary, more detailed information can be seen. FIG. 11 shows an example of information displayed in the case where the button of the information from management company of FIG. 3 is selected. In FIG. 11, selectable items relating to the management company are indicated at respective lines, and those can be selected to obtain necessary information.

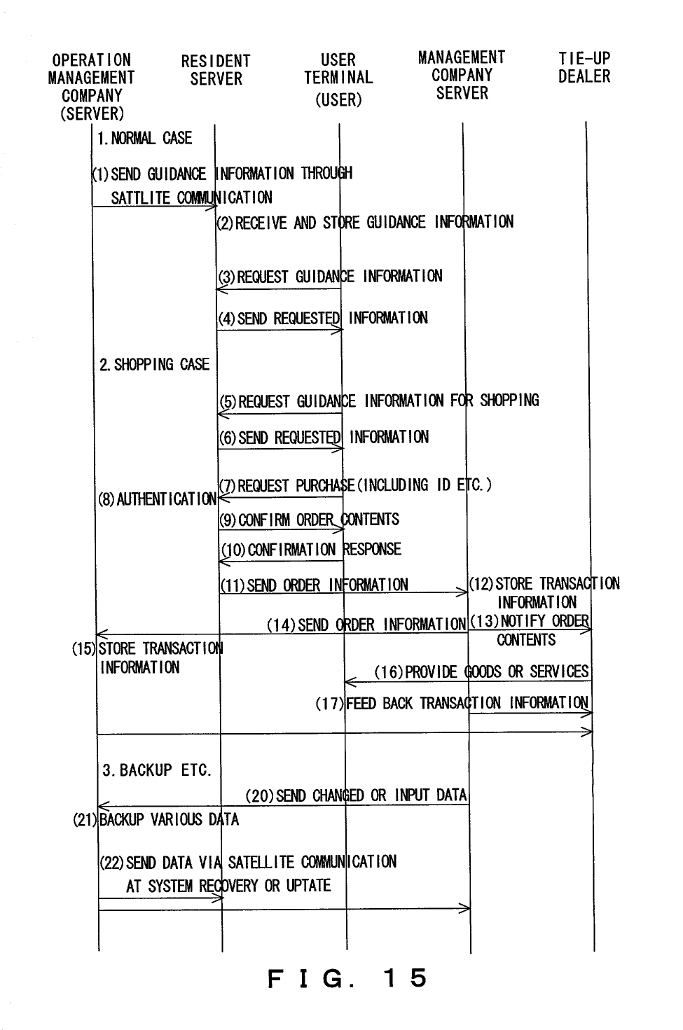

FIG. 12 shows an example of information displayed in the case where the button of the Internet of FIG. 3 is selected. In FIG. 12, an e-mail or a homepage can be selected, and if the e-mail is selected, transmission and reception of e-mail becomes possible. Further, when the homepage is selected, countless homepages existing in the Internet can be browsed. Incidentally, in FIG. 2, the resident server 130 is connected to the Internet, and the respective user terminals 200 access the Internet through this resident server 130. This is an example, and it is also possible to establish a connection with the Internet by another server instead of the resident server 130, for example, the server installed in the management company or the server installed in the operation management company.

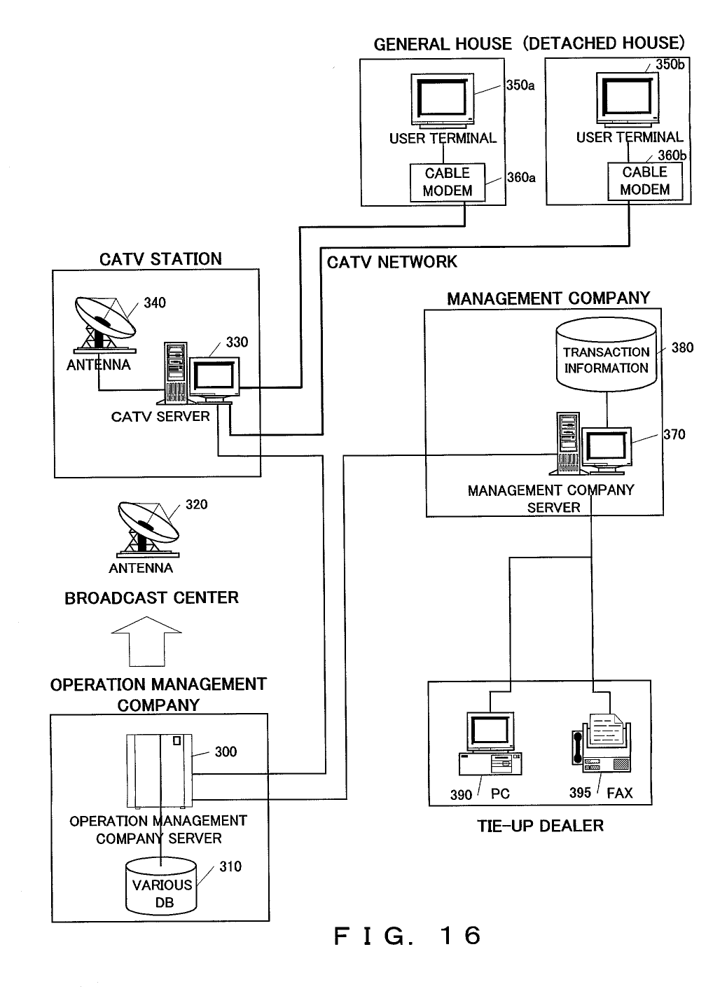

FIG. 13 shows an example of information displayed in the case where the button of the goods ordering in FIG. 3 is selected. In FIG. 13, although only one tie-up dealer can be selected, items of many tie-up dealers can be provided at respective lines. When the tie-up dealer shown in FIG. 13 is selected, the screen becomes as shown in FIG. 14. In FIG. 14, some commodities are displayed, and detailed information can be seen if a “DETAIL” button is selected. When the “DETAIL” button is touched, the screen is displayed, which is designed such that in addition to the detailed information of the commodity, a purchase request for the commodity can be made. When the purchase request is made after identification information and a password are inputted and a payment method is specified, the screen of purchase request confirmation is displayed. Then, when a confirmation button is selected, the purchase request is transmitted to the management company server 160 and the operation management company server 180, and is notified to the tie-up dealer.

The display screen examples of FIGS. 3 to 14 are examples, and the present invention is not limited to these display screens. Besides, the items shown in FIG. 3 are also not limited to these. In the present invention, what has a large data size, for example, the image information in FIGS. 3 to 14, the database for the medical search system of FIG. 8, or the like is distributed through the satellite communication from the operation management company. However, it is also possible to distribute other information, that is, character information through the satellite communication.

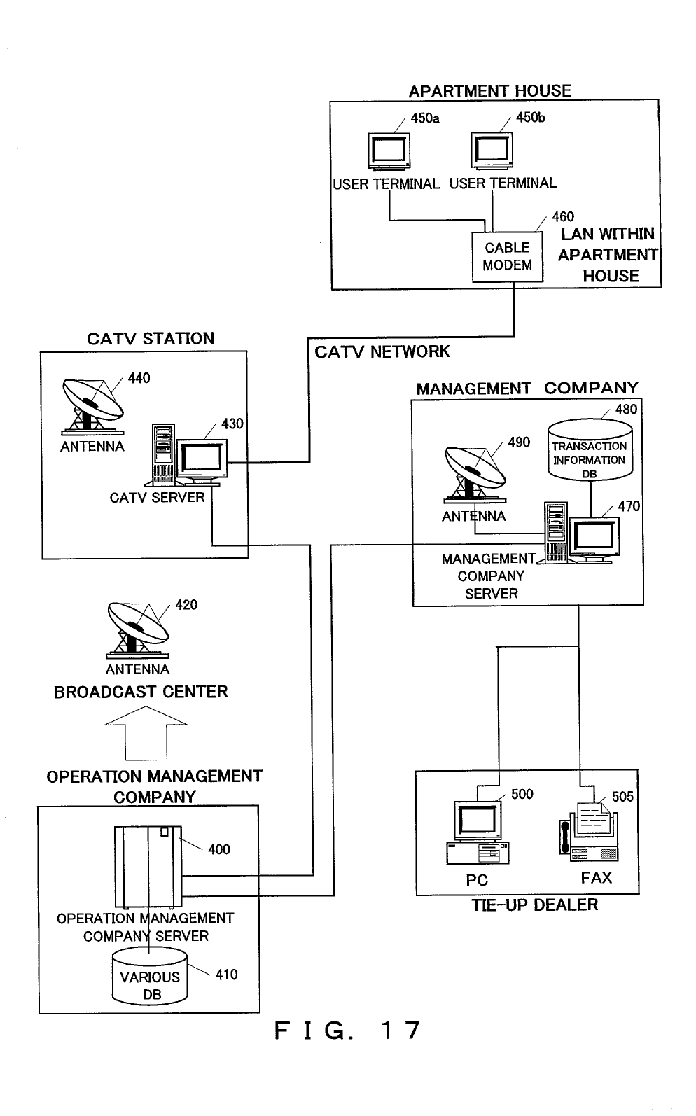

In FIG. 15, the flow of information among the operation management company (operation management company server 180), the resident server 130, the user terminal 200 (user), the management company server 160, and the tie-up dealer is summarized. In a normal case other than shopping, at least part of the guidance information is distributed from the operation management company through the satellite communication to the resident server 130 in advance (step (1)). This distributed guidance information is received by the antenna 120 of the resident server 130 and is stored in the resident server 130 (step (2)). Thereafter, in response to a guidance information request from the user terminal 200 (step (3)), the resident server 130 transmits requested guidance information to the user terminal 200 (step (4)). By repeating steps (3) and (4), the user can obtain necessary guidance information.

Also in the case of shopping, similarly, information for shopping is distributed to the resident server 130 from the operation management company through the satellite communication in advance (omitted in FIG. 15). In the case where a resident performs shopping, a request for guidance information relating to the shopping is transmitted from the user terminal 200 similarly to the normal case (step (5)), and the resident server 130 transmits the requested guidance information relating to the shopping to the user terminal 200 (step (6)). After the steps (5) and (6) are repeated, in the case where the user determines to purchase a commodity or a service, a purchase request is made from the user terminal 200 (step (7)) In this purchase request, input of identification information and a password may be requested. Besides, input of a payment method may also be requested to specify at this stage. In the case where the identification information, the password, and the like are inputted, the resident server 130 carries out an authentication processing, and if it is confirmed that the user is a proper user, confirmation of ordering contents is transmitted to the user terminal 200 (step (9)). For example, such a display as “The commodity to be purchased is AAA, and the sum is ZZZZ yen. The payment method is a XXXX credit card. Do you agree?” is presented on the display device of the user terminal 200. In the case where the resident server 130 receives a confirmation response to indicate agreement of the ordering contents from the user terminal 200 (step (10)), ordering information is transmitted to the management company server 160 (step (11)).

The management company server 160 which received the ordering information takes the ordering information and the user information of the user terminal 200 into the transaction information database (step (12)). For example, such information that a male of age xx purchases a commodity YYYY, is stored. This ordering information is also transmitted to the operation management company server 180 in the operation management company (step (14)), and is also stored in the transaction information database of the operation management company server 180 (step (15)). The management company server 160 notifies the tie-up dealer of the ordering contents (step (13)), and the tie-up dealer provides the user of the user terminal 200 with the ordered commodity or service (step (16)). A plurality of orders may be notified together. The tie-up dealer can receive the summarized transaction information stored in the management company server 160 or the operation management company server 180 as feedback at regular intervals or as the need arises, and can use it for its own business.

Since the management company performs resident management and the like, it makes a data input of a new resident, a modification of a resident and the like. When the data is inputted to the management company server 160, it is also automatically transmitted to the operation management company server 180 connected through the private line, and the operation management company server 180 also processes the data input (step (20)). This data becomes, for example, backup data, and is also managed by the operation management company server 180 (step (21)). Within the data stored in the resident server 130, data distributed from the operation management company is stored in the operation management company server 180. If necessary, a copy of data which is stored in the resident server 130 and was not distributed from the operation management company may be acquired by some method to be stored in the operation management company server 180. In the case where the management company server 160 or the resident server 130 gets out of order, the backup data stored in the operation management company server 180 is transmitted to the management company server 160 or the resident server 130 through the satellite communication for a system recovery (step (22)). Besides, also in the case where the system is updated, it is more effective if necessary data is distributed from the operation management company through the satellite communication (step (22)).

The resident server 130, the management company server 160, and the operation management company server 180 are programmed to perform the operations as described above, and necessary data are also stored in the computers.

The above described first preferred embodiment can be modified variously. For example, although the resident server 130 is installed in the apartment house or the like, it may be installed in the management company. Besides, a part of the functions of the management company server 160, for example, the notification function of the ordering contents or the like may be provided in the operation management company server 180. Further, it is also possible to provide all functions of the management company server 160 in the operation management company server 180. At this time, there is a case where the functions are completely embedded in the operation management company server 180 and a case where all functions are achieved by a group of plural servers. Such a configuration may be adopted that the ordering contents are notified from the resident server 130 to the tie-up dealer. Besides, although the authentication processing in shopping is carried out by the resident server 130, it may be carried out by the management company server 160. Besides, it is also possible to connect the resident server 130 and the operation management company server 180 by a wire or cable of a private line or the like. The user terminal 200 may be supplied as a dedicated terminal for the living information guidance system, or may have other functions, for example, a television function.

2. Second preferred embodiment

FIG. 16 is a view of the whole of a living information guidance system of a second preferred embodiment of the present invention. In the second preferred embodiment, there is shown an example in which a user terminal is installed in a general house (detached house). In the first preferred embodiment, although the resident server is installed in the apartment house or the like, it is often difficult to install a server in a general house. Thus, in the second preferred embodiment, a CATV server 330 equivalent to the resident server is installed in a cable television (CATV) station.

As shown in FIG. 16, an operation management company is equipped with an operation management company server 300 and various databases (DB) 310 connected thereto. As described in the first preferred embodiment as well, the various databases 310 include, for example, contents, transaction information, user needs, customer information, and the like. A broadcast center is equipped with an antenna 320 for transmitting data, distribution of which through satellite communication is requested by the operation management company, to a satellite. The CATV station is equipped with an antenna 340 for receiving the data transmitted from the satellite, and the CATV server 330 connected thereto.

The general house is equipped with a cable modem 360 connected to a program transmission signal line (optical fiber cable or coaxial cable) used for transmission of a normal cable television program from the CATV station and a touch panel type user terminal 350 connected to the cable modem 360. Incidentally, in the case where the user terminal 350 can be directly connected to the program transmission signal line, the cable modem 360 becomes unnecessary. FIG. 16 shows two general houses, and “a” is affixed to the reference numerals of the cable modem and the user terminal of the first house, and “b” is affixed to the reference numerals of the cable modem and the user terminal of the second house. However, the number of general houses which can be handled by the present invention is not limited to two.

A management company for the general house or the like is equipped with a management company server 370 and a transaction information database 380 connected to the management company server 370. A tie-up dealer is equipped with, for example, a FAX 395 or a computer 390.

In FIG. 16, the operation management company server 300 and the CATV server 330 are connected through, for example, a private line, and the CATV server 330 and the cable modem 360 are connected through a CATV network composed of the program transmission signal line. The operation management company server 300 and the management company server 370 are connected through, for example, a private line, and the management company server 370 and the computer 390 of the tie-up dealer are also connected through, for example, a private line. Incidentally, transmission of data from the operation management company to the CATV station may be carried out by the satellite communication through the antenna 320 of the broadcast center and the satellite.

The CATV server 330 in the second preferred embodiment has the same function as the resident server of the first preferred embodiment, and transmits, in response to a request from the user terminal 350, stored living guidance information to the user terminal 350 as a requester.

The operation management company and the function of the operation management company server 300 are almost the same as those of the first preferred embodiment. That is, the operation management company creates contents which will be stored in the CATV server 330 and provided for the user, collects material and information for that, and carries out management system operation assistance of the management company or executes operations for the management company server 370 or the like on behalf of the management company. The operation management company server 330 maintains and manages the customer information database and the transaction information database on the basis of the customer information transmitted from the management company server 370 and the transaction information transmitted from the CATV server 330. Incidentally, in FIG. 16, the CATV server 330 and the management company server 370 are not directly connected. Therefore, a function is added to the operation management company server 300 to transfer the ordering information relating to the order transmitted from the CATV server 330 to the management company server 370 of the management company for managing the tie-up dealer of the order destination in the case where an order for a commodity or a service is issued from the user terminal 350.

The function of the management company server 370 is also substantially the same as the first preferred embodiment. By the management company server 370, necessary information can be put on a bulletin board provided in the CATV server 330, or individual e-mail can be transmitted to the residents. In the case where shopping using the user terminal is performed, the ordering information of the commodity or the service is stored in the transaction information database 380 of the management company server 370. However, in FIG. 16, since the management company server 370 is not directly connected to the CATV server 330, in order to store the living guidance information from the management company into the CATV server 330, the data is transmitted through the operation management company server 300. The relation between the management company server 370 and the computer 390 or the FAX 395 of the tie-up dealer is the same as that of the first preferred embodiment.

In the case of the system configuration as stated above, by using the existing communication network of the CATV station, it becomes easy to provide the living guidance information for the detached house as well. In the case where the operation management company and the CATV station can communicate through the satellite communication, even if the CATV stations are dotted in a wide area, the operation management company can easily provide similar services for many stations. In the case of the CATV station covering a wide area or in the case where communication networks of a plurality of CATV stations are connected, there is also a case where many CATV servers 330 are connected to the communication network of the CATV stations, and the program transmission signal line with a broad band brings the same effect as the satellite communication. The CATV station can effectively use the existing communication network, and this embodiment also leads to new service provision.

Incidentally, the second preferred embodiment is not limited to that shown in FIG. 16, for example, the CATV server 330 and the management company server 370 may be connected through a private line or a program transmission signal line constituting the CATV network. In the case where the CATV server 330 and the management company server 370 are connected through the program transmission signal line, a cable modem may be needed. Besides, also in the second preferred embodiment, since there is a case where the management company does not exist or the management company entrusts the operation of the management company server 370 to the operation management company, it is also possible to connect the operation management company server 300 and the computer 390 of the tie-up dealer through, for example, a private line. Besides, a connection with the Internet is established from the CATV server 330 or the operation management company server 300. Further, the function of the management company server 370 may be provided in the CATV server 330.

3. Third preferred embodiment

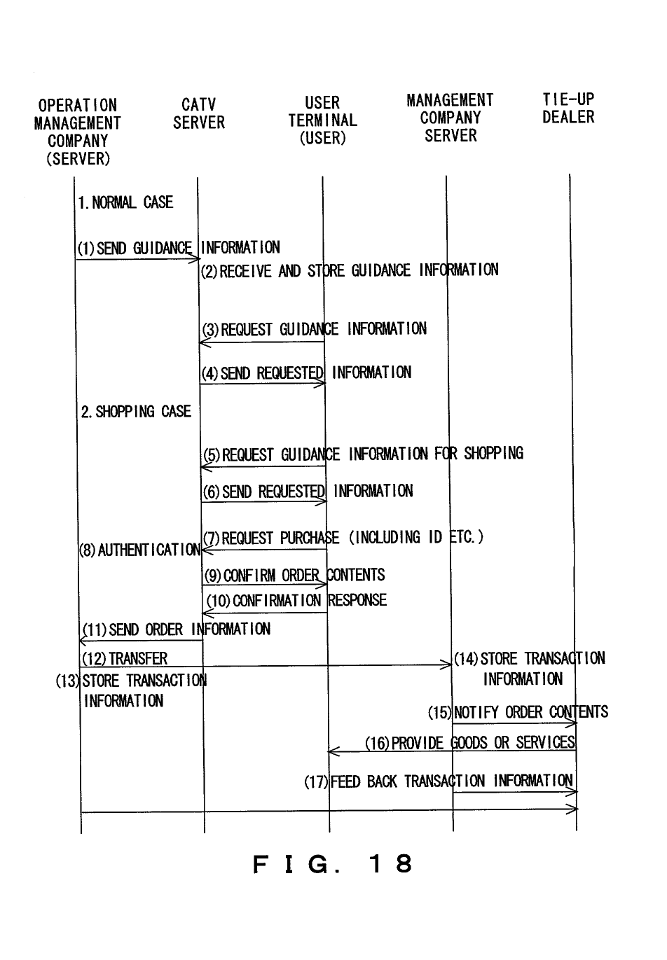

FIG. 17 shows a view of the whole of a living information guidance system of a third preferred embodiment of the present invention. In the third preferred embodiment, although a user terminal is installed for each house of an apartment house, a resident server is not installed in the apartment house, but instead, a CATV server is installed in a CATV station as in the second embodiment.

As shown in FIG. 17, an operation management company is equipped with an operation management company server 400 and various databases (DB) 410 connected thereto. As described in the first preferred embodiment as well, the various databases 410 include, for example, contents, transaction information, user needs, customer information, and the like. A broadcast center is equipped with an antenna 420 for transmitting data, distribution of which through satellite communication is requested by the operation management company, to a satellite. A CATV station is equipped with an antenna 440 for receiving the data transmitted from the satellite and a CATV server 430 connected thereto.

An apartment house is equipped with a cable modem 460 connected to a program transmission signal line (optical fiber cable or coaxial cable) used for transmitting a normal cable television program from the CATV station, and a terminal 450 of a touch panel type connected to the cable modem 460. The user terminal is equipped for each house of the apartment house, and in FIG. 17, “a” is affixed to the reference numeral of the user terminal of the first house, and “b” is affixed to the reference numeral of the user terminal of the second house. However, in the present invention, the number of the user terminals which can be connected to the cable modem 460 is not limited to two. A LAN in the apartment house is constructed by the cable modem 460, the user terminals 450, and signal lines connecting them.

A management company of the apartment house or the like is equipped with a management company server 470, a transaction information database 480 connected to the management company server 470, and an antenna 490 for receiving data transmitted from a satellite (not shown). The data received from the satellite is, for example, maintenance or recovery data of the management company server 470. A tie-up dealer is equipped with, for example, a FAX 505 or a computer 500.

In FIG. 17, the operation management company server 400 and the CATV server 430 are connected through, for example, a private line, and the CATV server 430 and the cable modem 460 are connected through a CATV network composed of a program transmission signal line. The operation management company server 400 and the management company server 470 are connected through, for example, a private line, and the management company server 470 and the computer 500 of the tie-up dealer are also connected through, for example, a private line. Incidentally, transmission of data from the operation management company to the CATV station may be carried out by the satellite communication through the antenna 320 of the broadcast center and the satellite. As described before, in the case where the amount of data is large, transmission of the data from the operation management company to the management company may also be carried out by the satellite communication through the satellite.

The CATV server 430 in the third preferred embodiment has the same function as the resident server of the first preferred embodiment, and transmits, in response to a request from the user terminal 450, the stored living guidance information to the user terminal 450 as the requester.

The operation management company and the function of the operation management company server 400 are also substantially the same as those of the first preferred embodiment. However, similarly to the second preferred embodiment, in FIG. 17, the CATV server 430 and the management company server 470 are not directly connected. Thus, a function is added to the operation management company server 400, to transfer the ordering information relating to the order transmitted from the CATV server 430 to the management company server 470 of the management company for managing the tie-up dealer as the order destination in the case where an order for a commodity or a service is issued from the user terminal 450.

The function of the management company server 470 is also substantially the same as the first preferred embodiment. However, similarly to the second preferred embodiment, in FIG. 17, since the management company server 470 is not directly connected to the CATV server 430, in order to store the living guidance information from the management company into the CATV server 430, the data is transmitted through the operation management company server 400. The relation between the management company server 470 and the computer 500 or the FAX 505 of the tie-up dealer is the same as the first preferred embodiment.

When the system structure as stated above is adopted, in the case of the apartment house which is already connected to the CATV station, it becomes easy to provide the living guidance information of the present invention. Besides, in the apartment house, facilities for the satellite communication become unnecessary. In the case where the operation management company and the CATV station can communicate through the satellite communication, even if the CATV stations are dotted in a wide area, the operation management company can easily provide similar services to many CATV stations. In the case of the CATV station covering a wide area or in the case where communication networks of a plurality of CATV stations are connected, there is also a case where many CATV servers 430 are connected to the communication networks of the CATV stations, and the program transmission signal line with a broad band has the same effect as the satellite communication. The CATV station can effectively use the existing communication network, and the present invention also leads to new service provision.

Incidentally, the third preferred embodiment is not limited to what is shown in FIG. 17, for example, the CATV server 430 and the management company server 470 may be connected through a private line or a program transmission signal line constituting the CATV network. In the case where the CATV server 430 and the management company server 470 are connected through the program transmission signal line, a cable modem may be needed. Besides, also in the third preferred embodiment, since there is a case where the management company does not exist or the management company entrusts the operation of the management company server 470 to the operation management company, it is also possible to connect the operation management company server 400 and the computer 500 of the tie-up dealer through, for example, a private line.

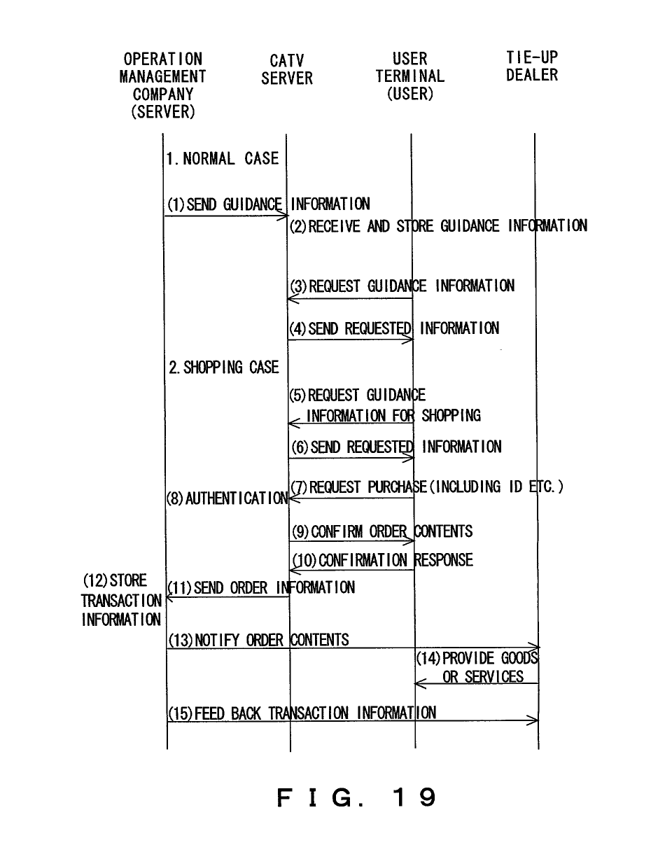

FIG. 18 summarizes the flow of information among the operation management company (operation management company server), the CATV server, the user terminal (user), the management company server, and the tie-up dealer. In a normal case other than shopping, at least part of guidance information is transmitted to the CATV server from the operation management company through the satellite or the private line in advance (step (1)). This transmitted guidance information is received by the CATV server and is stored in the CATV server (step (2)). Thereafter, in response to a guidance information request from the user terminal (step (3)), the CATV server transmits the requested guidance information to the user terminal (step (4)). By repeating the steps (3) and (4), the user can obtain necessary guidance information.

Also in the case of shopping, similarly, information for shopping is transmitted from the operation management company to the CATV server through the satellite or the private line in advance (omitted in FIG. 18). In the case where a resident performs shopping, similarly to the normal case, a request for guidance information relating to the shopping is transmitted from the user terminal (step (5)), and the CATV server transmits the requested guidance information relating to the shopping to the user terminal (step (6)). After the steps (5) and (6) are repeated, in the case where the user determines to purchase a commodity or a service, a purchase request is sent from the user terminal (step (7)). In this purchase request, input of identification information and a password may be requested. Besides, input of a payment method can also be requested to specify at this stage. In the case where the input of the identification information, the password or the like is made, the CATV server carries out an authentication processing, and if it is confirmed that the user is a correct user, the confirmation of the ordering contents is transmitted to the user terminal (step (9)). Thereafter, in the case where the CATV server receives a confirmation response indicating the agreement of the ordering contents from the user terminal (step (10)), the CATV server transmits the ordering information to the operation management company server (step (11)). This step (11) is different from the first preferred embodiment.

The operation management company server which received the ordering information transfers the ordering information to the management company server (step (12)), and takes the ordering information and information of the user of the user terminal into the transaction information database (step (13)). This ordering information is also stored in the transaction information database of the management company server installed in the management company (step (14)). The management company server notifies the tie-up dealer of the ordering contents (step (15)), and the tie-up dealer provides the ordered commodity or service for the user of the user terminal (step (16)). The tie-up dealer can receive the summary of the transaction information stored in the management company server or the operation management company server as feedback periodically or as the need arises (step(17)), and can use it for its own marketing.

The CATV server, the management company server, the user terminal, and the operation management company server are programmed to carry out the operations as described above, and necessary data are also stored in the computers.

Next, FIG. 19 summarizes the flow of information among the operation management company (operation management company server), the CATV server, the user terminal (user), and the tie-up dealer in the case where the management company server does not substantially exist in the second and third preferred embodiments, that is, in the case where the operation management company server of the second and third preferred embodiments carries out the function of the management company server. In a normal case other than shopping, part of the guidance information is transmitted to the CATV server from the operation management company through the satellite or the private line in advance (step (1)). The transmitted guidance information is received by the CATV server and is stored in the CATV server (step (2)). Thereafter, in response to a guidance information request from the user terminal (step (3)), the CATV server transmits the requested guidance information to the user terminal (step (4)). By repeating the steps (3) and (4), the user can obtain necessary guidance information.

Also in the case of shopping, similarly, information for shopping is transmitted from the operation management company to the CATV server through the satellite or the private line in advance (omitted in FIG. 19). In the case where a resident performs shopping, similarly to the normal case, a request for guidance information relating to the shopping is transmitted from the user terminal (step (5)), and the CATV server transmits the requested guidance information relating to the shopping to the user terminal (step (6)). After the steps (5) and (6) are repeated, in the case where the user determines to purchase a commodity or a service, a purchase request is made from the user terminal (step (7)). In this purchase request, input of identification information and a password maybe requested. Besides, input of a payment method can also be requested to specify at this stage. In the case where the input of the identification information, the password or the like is made, the CATV server carries out an authentication processing, and if it is confirmed that the user is a correct user, the confirmation of the ordering contents is transmitted to the user terminal (step (9)). Thereafter, in the case where the CATV server receives a confirmation response indicating the agreement of the ordering contents from the user terminal (step (10)), the CATV server transmits the ordering information to the operation management company server (step (11)). The steps up to the step (11) are the same as those of FIG. 18.

The operation management company server which received the ordering information takes the ordering information and the information of the user of the user terminal into the transaction information database (step (12)). The operation management company server also notifies the tie-up dealer of the ordering contents (step (13)), and the tie-up dealer provides the ordered commodity or service for the user of the user terminal (step (14)). The tie-up dealer can receive the summary of the transaction information stored in the operation management company server as feedback periodically or as the need arises, and can use it for its own marketing (step(15)).

The CATV server, the user terminal, and the operation management company server are programmed to carry out the operations as described above, and necessary data are also stored in the computers.

Incidentally, the flow of the information shown in FIG. 19 can be applied to not only the second and third preferred embodiments but also the first preferred embodiment if the CATV server of FIG. 19 is replaced by the resident server in a case where the management company server does not substantially function.

Although the present invention as described above can be carried out in the respective modes described in the respective preferred embodiments, the invention may be carried out in a combination of the first, second and third preferred embodiments.

As described above, there can be provided the convenient living information guidance system which is easy for the resident of the apartment house or the like to use. Besides, there can also be provided the living information guidance system which can reduce the load of management work for the management company of the apartment house or the like as well. Besides, there can also be provided the living information guidance system having such a shopping function that a person providing commodities or services can carry on more effective business.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A living information guidance system for enabling information provision and shopping in a user residential area, comprises:
a user terminal installed in a user residential building and including a display device;
a first server for storing guidance information for said information provision and said shopping in said user residential area, and transmitting information to said user terminal in response to a user's request; and
a second server including a transaction information database for storing information concerning shopping performed by a user of said user terminal, means for receiving and storing into said transaction information database, an order for a commodity or a service, said order issued by said user terminal in accordance with said guidance information for said shopping stored in said first server, and means for notifying said order for said commodity or said service to a dealer for providing said commodity or said service.

2. The living information guidance system as set forth in claim 1, wherein said display device of said user terminal is a touch panel type.

3. The living information guidance system as set forth in claim 2, wherein said user terminal has a function for receiving and transmitting e-mail.

4. The living information guidance system as set forth in claim 1, wherein said first server stores guidance information from a management company of said user residential building.

5. The living information guidance system as set forth in claim 1, further comprising:
a third server for storing backup data for said first and second servers,
wherein said backup data is distributed to said first or second server which requires said backup data.

6. The living information guidance system as set forth in claim 1, further comprising a forth server connected to said second server and installed in an operation management company, said fourth server storing information concerning orders for commodities or services.

7. The living information guidance system as set forth in claim 3, wherein said user terminal is capable of accessing the Internet.

8. The living information guidance system as set forth in claim 1, wherein at least part of said guidance information is distributed to said first server via satellite communication.

9. The living information guidance system as set forth in claim 1, wherein said first server is installed in a cable television station, and said first server and said user terminal are connected through a signal line for transmitting a cable television program.

10. The living information guidance system as set forth in claim 1, wherein said second server further comprises means for providing marketing information based on information stored in said transaction information database for said dealer for providing said commodity or said service.

11. A computer used in a living information guidance system enabling information provision and shopping in a user residential area, said living information guidance system comprising a user terminal installed in a user residential building and including a display device, and user response means for storing guidance information for said information provision and said shopping in said user residential area, and transmitting information to said user terminal in response to a user's request, said computer comprising:
a transaction information database for storing information concerning shopping performed by a user of said user terminal;
means for receiving and storing into said transaction information database, an order for a commodity or a service, said order issued by said user terminal in accordance with said guidance information for said shopping stored in said user response means; and
means for notifying said order for said commodity or said service to a dealer for providing said commodity or said service.

12. A living information guidance method for enabling shopping, comprising the steps of:
in response to a request from a user terminal installed in a user residential building and including a display device, transmitting guidance information concerning shopping from a user response means storing guidance information for information provision and said shopping in a user residential area;
if an order for a commodity or a service is received from said user terminal, storing into a transaction information database, information concerning said shopping a user of said user terminal performed; and
notifying said order for said commodity or said service to a dealer for providing said commodity or said service.

13. A program embedded on a medium for a living information guidance system enabling information provision and shopping in a user residential area, said living information guidance system comprising a user terminal installed in a user residential building and including a display device, and user response means for storing guidance information for said information provision and said shopping in said user residential area, and transmitting information to said user terminal in response to a user's request, said program comprising the steps of:
receiving an order for a commodity or a service, said order issued by said user terminal in accordance with said guidance information for said shopping stored in said user response means, and storing information concerning said shopping a user of said user terminal performed; and
notifying said order for said commodity or said service to a dealer for providing said commodity or said service.
